(19) United States
(12) Patent Application Publication
(10) Pub. No.: US 2019/0191191 A1
(43) Pub. Date: Jun. 20, 2019

(54) HYBRID TECHNIQUES FOR CONTENT DISTRIBUTION WITH EDGE DEVICES

(71) Applicant: Western Digital Technologies, Inc., San Jose, CA (US)

(72) Inventors: Jun Xu, Singapore (SG); David Blankenbeckler, Longmont, CO (US); Robin O'Neill, Trabuco Canyon, CA (US); Nils E. Larson, San Jose, CA (US)

(21) Appl. No.: 15/847,734

(22) Filed: Dec. 19, 2017

(51) Int. Cl. H04N 21/237; H04N 21/232; H04N 19/30; H04N 21/2343

(52) U.S. Cl. CPC H04N 21/237; H04N 21/234327; H04N 19/30; H04N 21/232

(57) ABSTRACT

Systems and methods to improve content distribution by reducing computational demand, optimizing network usage, and/or providing protection for content are disclosed. In some embodiments, the requested content can be encoded using scalable video coding with erasure coding and/or bit-level chunks coding. Scalable video coding can be used to create one or more base layers and/or one or more enhancement layers for a requested content. Bit-level chunk coding and/or erasure coding can be used to create fragments of the one or more layers. In some embodiments, the end point device, the edge network device, and/or the data center can select a policy for encoding the requested content based on a security level for the user device, a security level for an edge network device, a security level for a data center, a demand for the requested content, or a computational complexity for reconstructing the requested content.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The present disclosure relates to data or content distribution systems, and more particularly, to content distribution systems to improve network bandwidth usage and/or quality of experience for the end user.

### Description of the Related Art

Technological advances in video streaming services have allowed for more video content to reach end users and to provide higher quality video streaming services with faster response times. However, increased demand for such services have led to increase use of network bandwidth. As video technology, video servicing, network, and telecommunications technology continues to improve, more users may stream video and each user may stream more content. Furthermore, video quality may continue to improve, resulting in an increase in file size. Service providers have attempted to maintain a certain level of quality of experience for the user while at the same time reduce the network load during peak times by transmitting content ahead of time and allowing a user to view the content later. However, such approaches require early distribution and storage of sensitive content (such as, copyrighted episodes that have not yet been shown to the public). Service providers have used encryption techniques to provide protection and security for the early distributed sensitive content. But such an approach increases computational demand and design complexity on both the video streaming service provider and on the user device. As such, new methods and systems for distributing content to the user are needed that allows for scalability, optimized use of network bandwidth, and protection for sensitive content using current telecommunications infrastructure.

### BRIEF DESCRIPTION OF THE DRAWINGS

The innovations described in the claims each have several aspects, no single one of which is solely responsible for its desirable attributes. Without limiting the scope of the claims, some prominent features of this disclosure will now be briefly described.

FIG. 1A is a block diagram illustrating the transmission of content using erasure coding and scalable video coding according to some embodiments of the present disclosure.

FIG. 1B is a flow diagram illustrating responding to a request for content from a user according to some embodiments of the present disclosure.

FIG. 2A is a diagram illustrating scalable video coding according to some embodiments of the present disclosure.

FIG. 2B is a diagram illustrating erasure coding according to some embodiments of the present disclosure.

FIG. 3A is a diagram illustrating a butterfly network coding scheme according to some embodiments of the present disclosure.

FIG. 3B is a diagram illustrating a modified butterfly network coding scheme according to some embodiments of the present disclosure.

FIG. 4 is a block diagram illustrating a network infrastructure with edge network devices according to some embodiments of the present disclosure.

FIG. 5 is a flow diagram illustrating a selection between data transfer policies according to some embodiments of the present disclosure.

FIG. 6A is a decision tree diagram illustrating selection between two data transfer policies according to some embodiments of the present disclosure.

FIG. 6B is a decision tree diagram illustrating a selection between four data transfer policies according to some embodiments of the present disclosure.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions, and changes in the form of the methods and systems described herein may be made without departing from the scope of protection.

### Overview

Generally, some embodiments of systems and methods described herein improve content distribution (such as, video streaming content) by reducing computational demand, optimizing network usage, and/or providing protection for content. Some embodiments of the present disclosure describe the integration of scalable video coding with erasure coding for data storage. The integrated scalable video coding with an erasure coding scheme and/or bit-level chunk coding scheme for an edge network device can be used to determine content distribution and storage for content. In some embodiments, the content can be encoded using scalable video coding combined with an encoding mechanism, such as erasure coding, bit-level chunk coding, a combination of erasure coding and bit-level chunk coding, and the like.

Great progress has been made in video technology and data transfer technology. As a result, Internet users are transferring data to and from their personal computing devices at an ever-increasing rate. With the rise of global Internet traffic, the demand for bandwidth is leading to bandwidth bottlenecks and network peak times, where users experience lower quality in response to user requests for content, for example, for video streaming services.

Telecommunication companies and internet service providers often struggle with demand for streaming content due to the lack of available bandwidth caused either by bandwidth usage at certain time periods or limitations with existing infrastructure. To relieve such bandwidth requirements, copies of content can be stored at edge network devices located closer to end points instead of retrieving content directly from data centers. However, due to copyright laws for video content and the protections afforded to the content owners, telecommunication companies would have to obtain rights for each copy placed at an edge network device, which can become very costly. To effectively offload the data center, many edge network devices may have to be created, and each edge network device may have to store a copy of content likely requested by the user. Thus, telecommunication companies may not be financially incentivized to store multiple copies of content at the edge network devices. Furthermore, telecommunication companies may not want to send sensitive content directly to the user device for early distribution for protection and security of copyrighted content.

In some embodiments of the present disclosure, an edge network device can implement erasure coding (and/or other type of encoding mechanism) to create fragments of content, where the fragments of content can be used at a later time to reconstruct the streaming content. The edge network device can further implement scalable video coding to create layers for the content, such as a base layer and enhancement layers. For example, an edge network device can predict content that will likely be requested by an end point device and transmit a fragment of the content ahead of time for early distribution. Then, when the end point device receives a request for the content, the remaining content can be transmitted to the end point device. The early distributed fragment of the content can be encoded such that the content cannot be played and/or accessed without the remaining fragments. Upon request by the user on the endpoint device, the edge network device can transmit the remainder of the fragments of content to the end point (such as, a user computing device), and the end point can reconstruct the full streaming content by using the early distributed received fragments and the received remainder fragments. In some embodiments, upon request by the user on the endpoint device, the data center can transmit the remainder of the fragments of content to the edge network device, and the edge network device can reconstruct the full streaming content by using the early distributed received fragments and the received remainder fragments, and transmit the full streaming content to the end point device.

Advantageously, in some embodiments, computational workload is pushed onto the edge network device and/or the end point (such as, a user computing device). The early distribution of the subset of the fragments of content can be distributed when network bandwidth is available. Because only a subset of the fragments of the content is transmitted for early distribution, the end points and/or the edge network devices cannot reconstruct the full streaming content until the end points and/or the edge network devices receive the remainder of the fragments of the content, and as such, the content is protected from copyright violations. Furthermore, because only the remainder of the fragments of the content is transmitted at the time of the user request, the network bandwidth usage in response to the user request is reduced.

In some embodiments, the end point device, the edge network device, and/or the data center can select a policy for encoding the requested content. The policies that can be selected can include scalable video coding, scalable video coding with bit-level chunk coding, scalable video coding with erasure coding, scalable video coding with erasure coding and bit-level chunk coding, and/or the like. In some embodiments, the selection of the policy can be based on a security level for the user device, a security level for an edge network device, a security level for a data center, a demand for the requested content, a computational complexity for reconstructing the requested content, and/or the like. Advantageously, the end point device, the edge network device, and/or the data center can autonomously select a policy optimized for the level of security desired. The end point device, the edge network device, and/or the data center can further tailor transmission and/or reception of content based on optimization of the demand, security levels required for devices in the system, and computational complexity.

Various embodiments of this disclosure provide device comprising: a memory; and one or more processors configured to, in response to receiving a request to access video data from a user device, the video data encoded using erasure coding into a base layer of a scalable video coding scheme, the base layer comprising a plurality of base layer chunks and at least one parity layer chunk: identify one or more base layer chunks of the plurality of base layer chunks not yet transmitted to the user device; retrieve the one or more base layer chunks from the memory or request transmission of the one or more base layer chunks from a data center; and transmit the one or more base layer chunks to the user device using network coding, wherein each of the plurality of base layer chunks and the at least one parity layer chunk are required to be transmitted to the user device to enable playback of the video data by the user device.

The device of the preceding paragraph can include one or more of the features described in the following paragraphs as well as elsewhere in the specification. In some embodiments, the one or more processors are further configured to: determine that the at least one parity layer chunk has not yet been transmitted to the user device; and in response to the determination, retrieve the at least one parity layer chunk from the memory or request transmission of the at least one parity layer chunk from the data center and transmit the at least one parity layer chunk to the user device.

In some embodiments, the one or more processors are further configured to: search for the one or more base layer chunks in the memory, wherein the memory is a local memory datastore; in response to finding the one or more base layer chunks in the memory, retrieve the one or more base layer chunks from the memory; and in response to not finding the one or more base layer chunks in the memory, request transmission of the one or more base layer chunks from the data center.

In some embodiments, at least one base layer chunk other than the one or more base layer chunks is stored by the user device.

In some embodiments, the video data is further encoded using erasure coding into at least one enhancement layer divided into a plurality of enhancement layer chunks each of which is required to playback enhanced video data by the user device, and wherein the one or more processors are further configured to: identify one or more enhancement layer chunks of the plurality of enhancement layer chunks not yet transmitted to the user device; retrieve the one or more enhancement layer chunks from the memory or request transmission of the one or more enhancement layer chunks from the data center; and transmit the one or more enhancement layer chunks to the user device.

In some embodiments, at least one enhancement layer chunk other than the one or more enhancement layer chunks is stored by the user device.

In some embodiments, the video data is encoded into the base layer and the at least one enhancement layer using the scalable video coding scheme.

In some embodiments, the network coding comprises a butterfly network and a multicast session.

In some embodiments, the network coding comprises a modified butterfly network and two unicast sessions. Some embodiments include a system comprising the device, wherein the device includes an edge network device.

Various embodiments of this disclosure provide a device, where the device can comprise a memory; and one or more processors configured to, in response to receiving a request to access data from a user device, the data comprising a base layer divided into plurality of base layer chunks each of which is required by the user device to access the data: identify one or more base layer chunks of the plurality of base layer chunks not yet transmitted to the user device; retrieve the one or more base layer chunks from the memory or request transmission of the one or more base layer chunks from a data center; and transmit the one or more base layer chunks to the user device.

The device of the preceding paragraph can include one or more of the features described in the following paragraphs as well as elsewhere in the specification. In some embodiments, the one or more processors are further configured to: search for the one or more base layer chunks in the memory, wherein the memory is a local memory datastore; in response to finding the one or more base layer chunks in the memory, retrieve the one or more base layer chunks from the memory; and in response to not finding the one or more base layer chunks in the memory, request transmission of the one or more base layer chunks from the data center.

In some embodiments, at least one base layer chunk other than the one or more base layer chunks is stored by the user device.

In some embodiments, the data further comprises at least one enhancement layer divided into a plurality of enhancement layer chunks each of which is required to access the data by the user device, and wherein the one or more processors are further configured to: identify one or more enhancement layer chunks of the plurality of enhancement layer chunks not yet transmitted to the user device; retrieve the one or more enhancement layer chunks from the memory or request transmission of the one or more enhancement layer chunks from the data center; and transmit the one or more enhancement layer chunks to the user device.

In some embodiments, at least one enhancement layer chunk other than the one or more enhancement layer chunks is stored by the user device.

In some embodiments, the base layer is divided into the plurality of base layer chunks using erasure coding, and wherein the at least one enhancement layer is divided into the plurality of enhancement layer chunks using erasure coding.

In some embodiments, the one or more processors are further configured to transmit the one or more base layer chunks to the user device using network coding.

In some embodiments, the one or more processors are further configured to select a policy for transmitting the one or more base layer chunks to the user device, and wherein the policy is based on at least one of: a security level for the user device, a security level for the device, a demand for the data, or a computational complexity for the data. Some embodiments include a system comprising thee device, wherein the device includes an edge network device.

Various embodiments of this disclosure provide a method of transmitting data to a user device, the method comprising: by a device, in response to receiving a request for content from a user device: identifying one or more base layer chunks of a plurality of base layer chunks not yet received; retrieving already received one or more base layer chunks of the plurality of base layer chunks from a memory of the device; requesting the one or more base layer chunks not yet received from a data center; receiving the one or more base layer chunks not yet received from a data center; reconstructing the requested content based on the retrieved one or more base layer chunks and the received one or more base layer chunks, wherein each of the plurality of base layer chunks are required to reconstruct the requested content; and transmitting the requested content to the user device.

The method of the preceding paragraph can include one or more of the features described in the following paragraphs as well as elsewhere in the specification. In some embodiments, the method further comprises selecting a policy for transmitting the one or more base layer chunks to the user device, wherein the policy comprises at least one of: scalable video coding with bit-level chunk coding; scalable video coding with erasure coding; or scalable video coding with bit-level chunk and erasure coding.

In some embodiments, the policy is based on at least one of: a security level for the user device, a security level for a device, a security level for a data center, a demand for the requested content, or a computational complexity for reconstructing the requested content.

Various embodiments of this disclosure provide a device comprising one or more processors configured to, in response to receiving a request to access data from a user device, the data comprising a base layer divided into plurality of base layer chunks each of which is required by the user device to access the data: identify one or more base layer chunks of the plurality of base layer chunks not yet transmitted to the user device; retrieve the one or more base layer chunks from the memory or request transmission of the one or more base layer chunks from a data center; and transmit the one or more base layer chunks to the user device. Some embodiments include a system comprising the device, wherein the device includes an edge network device.

### Hybrid Techniques Overview

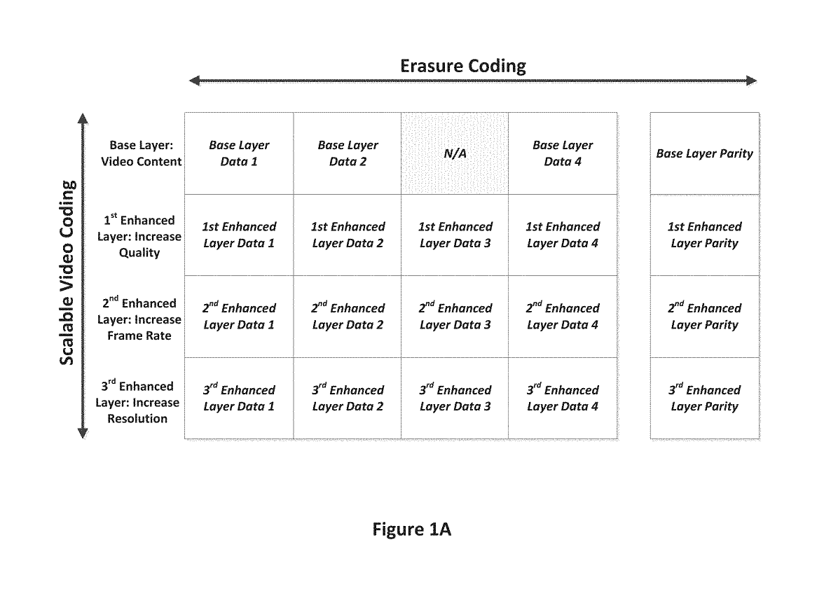

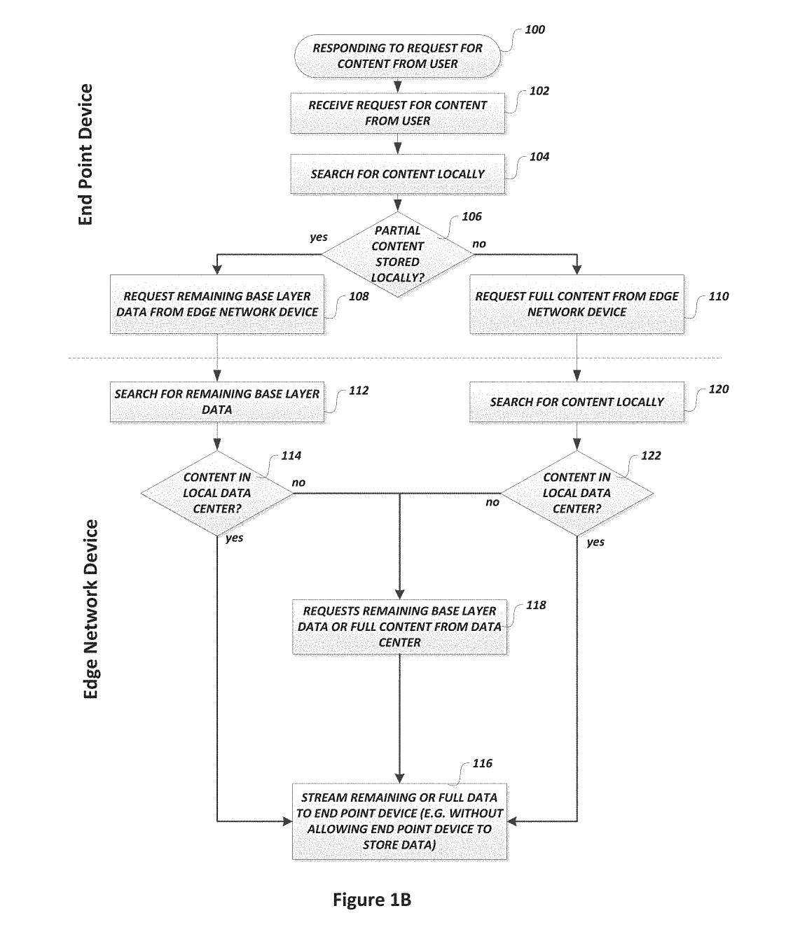

FIG. 1A is a block diagram illustrating the transmission of content using erasure coding and scalable video coding according to some embodiments of the present disclosure. In some embodiments, video content can be encoded into a base layer and enhancement layers. For example, the base layer can include the video content at a low quality. The one or more enhancement layers can include enhancement for the video content. For example, the enhancement layers can add to the video content in the base layer by increasing the quality of the video, increasing the frame rate of the video and/or increasing the resolution of the video. In some embodiments, the enhancement layers can comprise different variations and/or levels of a characteristic. For example, one enhancement layer can improve the resolution to a certain degree, and a second enhancement layer can improve the resolution to another degree. In some embodiments, the enhancement layer can provide a change in video frame rate, data rate, video bit rate, audio bit rate, resolution, duration, video codec, audio codec, variation in file type, channel, picture size, signal-to-noise ratio, fidelity scalability, and/or the like of the content in the base layer.

In some embodiments, one or more layers can be fragmented. For example, as shown in the illustration of FIG. 1A, a base layer can be fragmented into four base layer data blocks and a base layer parity block. The one or more enhancement layers can be fragmented. For example, as shown in the illustration of FIG. 1A, each enhancement layer can be fragmented into four enhancement layer data blocks and an enhancement layer parity block. In some embodiments, the fragmentation can be performed by erasure coding, bit level chunk, and/or other form of fragmentation. In some embodiments, the content (such as, the video content) cannot be retrieved unless certain blocks are received (such as, the base layer data block fragments 1, 2, 3, and 4).

In some embodiments, a subset of the fragments can be transmitted to the end point device and/or an edge network device for early distribution. For example, as shown in the illustration of FIG. 1A, three of the four base layer data chunks (such as, base layer data block 1, 2, and 4) and the base layer parity block are transmitted to the end point device for early distribution. In this example, all fragments of the enhancement layers are also transmitted to the end point device. Because one of the fragments of the base layer (such as, base layer data block 3) has not yet been transmitted to the end point device and/or the edge network device, the full content cannot be accessed. Advantageously, a substantial portion of the video content can be transmitted to the end point device at early distribution, and only a small subset (such as, a fragment) is to be transmitted for the end point and/or the edge network device to have access to the full content. In the example of FIG. 1A, upon request of a user, the edge network device and/or the data center can transmit the base layer data block 3 to the end point for the end point to reconstruct the full content. In some embodiments, the data center can transmit the base layer data block 3 to the edge network device for the edge network device to reconstruct the full content and send the full content to the end point device.

Responding to a Request for Content from a User

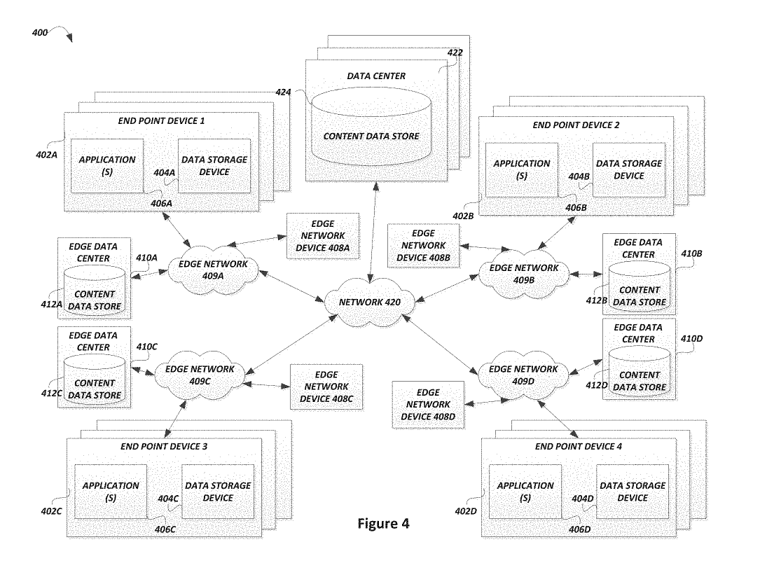

FIG. 1B is a flow diagram illustrating responding to a request for content from a user according to some embodiments of the present disclosure. The illustrated process can be executed by one or more elements of the network illustrated in FIG. 4, or elsewhere in the specification. In certain embodiments, the illustrated process can be at least partially implemented by an edge network device and/or an end point device. The process may also be performed by a processor that is separate from the edge network device and/or the end point device (such as, a data center, a software defined storage controller, a software defined network controller, and the like), by another device under directions from a separate processor, and the like.

The process starts at step 100. Next, in step 102, an end point device can receive a request for content from a user. The content from the user can be a request for video content, audio content, multi-media content, text content, and/or the like.

In step 104, the end point device can search for the requested content locally. For example, the end point device can search for the requested content in a local memory, a cache, a buffer, and/or the like.

In step 106, if at least partial content (such as, a subset of the fragments for the content) is stored locally, then at step 108, the end point device can request the remaining content from the edge network device. For example, the partial content can include a subset of fragments for the base layer and all fragments for enhancement layers. The end point device can then request the remaining fragments for the base layer from an edge network device. If no content is stored locally, at step 110, the end point device can request the full content from the edge network device.

If the end point device requests the remaining content from the edge network device, at step 112, the edge network device can receive the request for the remaining fragments and search for the remaining fragments (such as, search for the remaining base layer data) in a local data base.

In step 114, the edge network device can determine whether the content is stored in a local data center. If the content is stored locally, the edge network device can stream the remaining data to the edge device in step 116. In some embodiments, the remaining data can be streamed to the end point device without allowing the edge device to store the data. Thus, advantageously, the end point device may not have access to the full content except for when the remaining data is streamed.

In step 114, if the edge network device determines that the content is not stored locally, in step 118, the edge network device can request the remaining base layer data from a data center, and at step 120, can stream the remaining data to the end point device.

In step 110, after the end point device requests the full content from the edge network device, the edge network device can search for the content locally in step 120. If the content is stored locally at step 122, the edge network device can stream the full data to the end point device in step 116. If the content is not stored locally at step 122, then the edge network device can request the full content from the data center in step 118 and stream the full content to the end point device in step 116.

### Scalable Video Coding

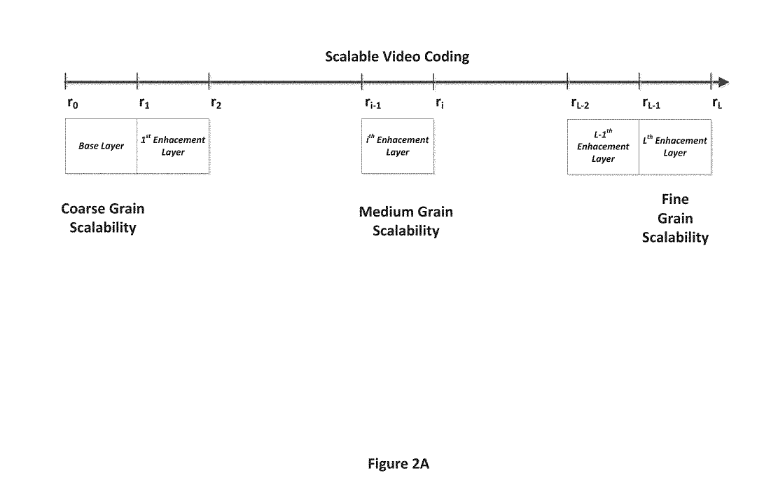

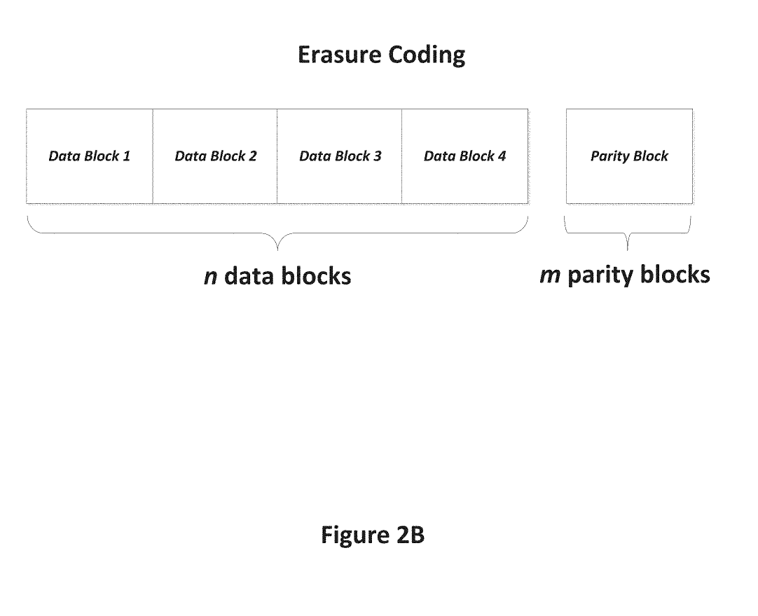

In some embodiments, content can be divided into layers. For example, scalable video coding can be used to divide video content into base and enhancement layers. FIG. 2A is a diagram illustrating scalable video coding according to some embodiments of the present disclosure. Scalable video coding scheme can be used with any of the embodiments of data transmission described herein.

In some embodiments, scalable video coding can be used to enable scalability of video transmission. For example, scalable video coding can enable high video quality for laptops whereas lower video quality can be transmitted to a mobile device. Advantageously, scalable video coding can enable the generation of subsets of bit streams on the same content to manage bandwidth consumption. For example, a mobile phone may receive only a base layer whereas a laptop may receive all of the layers.

In some embodiments, scalable video coding includes the generation of a subset of bitstreams for a particular content. For example, the content can include video content, and the subset of bitstreams can include one or more base layers and/or one or more enhancement layers. For example, the base layer can include the video content at a certain quality. The one or more enhancement layers can include enhancement for the video content. For example, the enhancement layers can add to the video content in the base layer by increasing the quality of the video, increasing the frame rate of the video and/or increasing the resolution of the video. In some embodiments, the enhancement layers can comprise different variations and/or levels of a characteristic. For example, one enhancement layer can improve the resolution to a certain degree, and a second enhancement layer can improve the resolution to another degree. In some embodiments, the enhancement layer can provide a change in video frame rate, data rate, video bit rate, audio bit rate, resolution, duration, video codec, audio codec, variation in file type, channel, picture size, signal-to-noise ratio, fidelity scalability, and/or the like of the content in the base layer.

### Erasure Coding

FIG. 2B is a diagram illustrating an erasure coding scheme according to some embodiments of the present disclosure. Erasure coding scheme can be used with any of the embodiments of data transmission described herein. In some embodiments, the edge network device and/or a software defined storage (SDS)/software defined networking (SDN) controller can implement an erasure coding scheme to fragment the content. In some embodiments, for each erasure coding scheme configuration, each scheme can be divided into a total of n blocks with k as data blocks. Based on the level of desired protection, the number of data blocks can differ. For example, if a higher protection level is desired, then a higher n-k can be used.

In some embodiments, erasure coding can include a method of data protection in which data is broken into fragments, expanded and encoded with redundant data pieces, and stored across a set of different locations or storage media. In some embodiments, the content can be fragmented into one or more data blocks and/or one or more parity blocks. In the example of FIG. 2B, the content is fragmented into four data blocks and one parity block. Although FIG. 2B illustrates systematic erasure coding in which input data is embedded in the encoded output, systems and method disclosed herein can be used with non-systematic erasure coding in which the encoded output does not include the input data.

In some embodiments, a declustered RAID system is used. Unlike traditional RAID systems, a declustered RAID system can allow users to create arbitrarily sized data storage device arrays. For example, different capacity of data storage devices with different performances can be mixed in the same system. In traditional RAID systems, the data stripe and parity stripe groupings can include a fixed structure. Each data storage device in the traditional RAID system has equalized capacity. Thus, when one data storage device fails, the system needs to rebuild the entire data storage device, resulting in a long rebuild time. In a declustered RAID system, the data storage devices can be divided into small virtual data chunks. The virtual data chunks can be regrouped into a virtual data RAID array. The spared virtual data chunk can be scattered among the data group. Thus, if one drive fails, the rebuilding process not affect the other drives, reducing the rebuild time.

For the erasure coding scheme on the storage node, the erasure coding scheme can be applied to a read request and/or a write request. For the write request, if the packets with both data and parity are received within a time window, the packets can be stored directly. Otherwise, the edge network device can reconstruct the missing parity and/or data pieces. If the storage protection level is higher than the communication erasure level, then the product erasure coding scheme can be applied with more parities. For a read request, the edge network device can determine whether to the read and parity from the storage or only the data with the parity calculated. In some embodiments, this determination is based on a cost function, such as a cost function for the CPU, memory, data storage access input and out (“I/O”), and the like.

Thus, a process based on a balancing on computation requirements and I/O operations can be implemented. For example, if the penalty for the CPU and storage indicates that the penalty for CPU cycles are higher than the penalty for reading the data from storage, the data can be reconstructed in real time by computers that do not have the data stored locally. Otherwise, the system can add more copies of the data such that the data is read in a single instruction, multiple data (“SIMD”) manner.

### Butterfly Network Coding

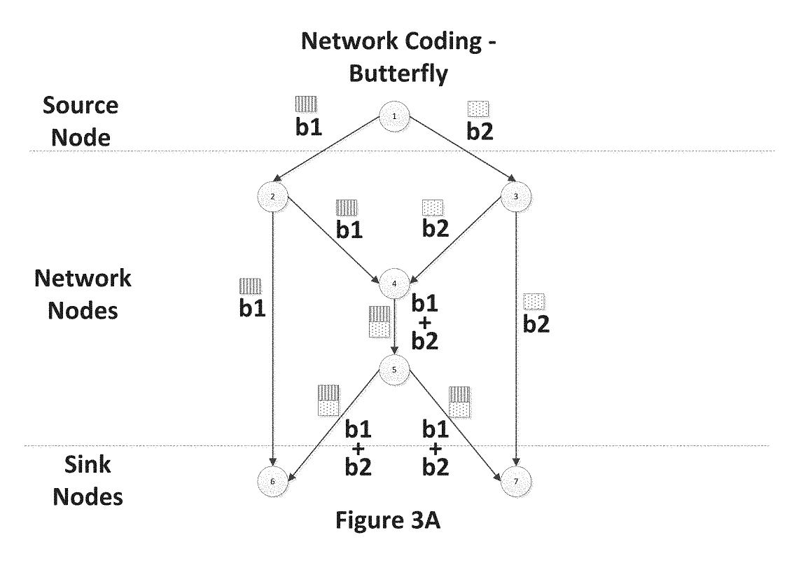

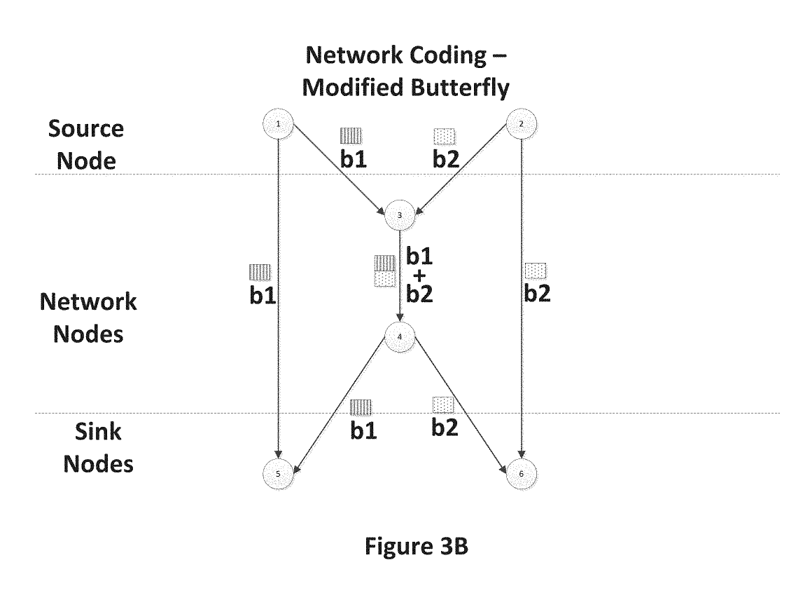

FIG. 3A is a diagram illustrating a butterfly network coding scheme according to some embodiments of the present disclosure. The illustrated network coding scheme can be used with any of the embodiments of data transmission described herein. In some embodiments, the edge network device and/or an SDS/SDN controller can implement a butterfly network coding scheme to transmit content to an end point device.

In some embodiments, the butterfly network comprises one or more source nodes, one or more network nodes, and one or more sink nodes. In the example butterfly network of FIG. 3A, the butterfly network comprises one source node, four network nodes, and two sink nodes. Each link between the nodes can have a unit capacity. In this example, two packets, b1 and b2, are to be transmitted from the source node 1 to the sink nodes 6 and 7.

A butterfly network coding scheme can be used to send information over network links. Instead of simply relaying packets, network nodes can be used to combine incoming packets and send the resulting coded packets to outgoing edges. Network coding can lead to augmented throughput, reduce vulnerability, and provide ease of deployment in a large-scale distribution system. Network coding can also improve throughput, delay, resilience to packet loss, and system complexity.

One shortcoming of network coding is that network coding requires processing in the middle of the network which can lead to additional delays, complexity, and vulnerability to byzantine attacks. However, erasure coding provides a viable solution to this shortcoming using in-network error control, such as Reed-Solomon codes, low density parity-check codes, turbo codes, LT codes, Raptor codes, and the like.

In this example, two packets, b1 and b2, and transmitted from the source node, node 1. The first packet, b1, is transmitted to network node 2, and the second packet, b2, is transmitted to network node 3.

The second network node transmits the first packet, b1, to both the network node 4 and the sink node 6. The third network node transmits the second packet, b2, to both the network node 4 and the sink node 7.

Intra-session network coding can be implemented on network nodes 4 and 5. Network node 4 combines the first and second packets, b1 and b2, and transmits the coded packet to network node 5. Network node 5 transmits the coded packet, b1 and b2, to both sink nodes 6 and 7. Sink node 6 received the first packet, b1, from the second network node, and can determine the second packet, b2, by subtracting the coded b1 and b2 packet from b1. As such, the two packets, b1 and b2, can be transmitted to both destinations, the sink nodes, simultaneously.

### Modified Butterfly Network Coding

FIG. 3B is a diagram illustrating a modified butterfly network coding scheme according to some embodiments of the present disclosure. In some embodiments, the edge network device and/or an SDS/SDN controller can implement a modified butterfly network coding scheme to transmit content to an end point device. The illustrated network coding scheme can be used with any of the embodiments of data transmission described herein.

In the example modified butterfly network of FIG. 3B, the modified butterfly network comprises two source nodes, two network nodes, and two sink nodes. In this example, a first packet, b1, is transmitted from the first source node, node 1. The first packet, b1, is transmitted to network node 3 and sink node 5. The second packet, b2, is transmitted from the second source node 2, to the network node 3 and the sink node 6. Intra-session network coding can be implemented on network nodes 3 and 4. Network node 3 combines the first and second packets, b1 and b2, and transmits the coded packet to network node 4. Network node 4 transmits the coded packet, b1 and b2, to both sink nodes 6 and 7.

For the network coding scheme of an in-network node, different network coding schemes can be selected. The selection can be based on network size. For example, for a small-to-medium network, deterministic network coding schemes can be used whereas for a large scale network, random schemes can be implemented for simple generation of policy. A pure random scheme for network coding can be selected when a fixed code for the storage side is desired (such as, when the coefficient matrix is fixed) and/or if an additional table on the storage side is used to record the random erasure coding scheme. In some embodiments, a group policy can be used, where the packets for the same chunk or file may use the same network coding matrix.

Network Infrastructure with Edge Network Devices

FIG. 4 is a block diagram illustrating a network infrastructure with edge network devices according to some embodiments of the present disclosure. The illustrated network infrastructure can be similar to that illustrated in FIG. 1. The network infrastructure can include end point device 1 402A, end point device 2 402B, end point device 3 402C, and end point device 4 402D (collectively referred to herein as endpoint devices 402). The end point devices 402 can include an application 406A, 406B, 406C, 406D (collectively referred to herein as applications 406) and/or a data storage device 404A, 404B, 404C, and 404D (collectively referred to herein as data storage devices 404). The network infrastructure can comprise edge network devices 408A, 408B, 408C, 408D (collectively referred to herein as edge network devices 408), edge networks 409A, 409B, 409C, 409D (collectively referred to herein as edge networks 409), an edge data center 410A, 410B, 410C, and 410D (collectively referred to herein as edge data centers 410), a data center 422, and core network 420 connecting the edge networks 409 and the data center 422. The edge data centers 410 can include a content data store 412A, 412B, 412C, 412D (collectively referred to herein as content data stores 412). The data center 422 can include a content data store 424.

In some embodiments, the edge network device 408 can be connected to the edge network 409 and/or can receive a request for content from the end point device 402. The edge network device 408 can search for the content locally in the edge data center 412 within the content data store 412. If the content is located locally, then the edge network device 408 can check the network condition to determine how the edge network device 408 will send the content to the end point device 402. If the content is not located locally, then the edge network device 408 can request the video content from the data center 422.

If the network condition is sufficient, the edge network device 408 can send the content directly to the end point device 402 without implementing network coding or identify pieces to reconstruct the data. If the network condition is not sufficient, the edge network device 408 can implement network coding to send the content to the user.

The edge network device 408 can check whether the requested packets exist in a cache or buffer. If the packets are in a cache or buffer of the edge network device 408, the edge network devices can send the packets to the user. If the packets are not in the cache or buffer, the edge network device can check penalty functions for computational processing and content retrieval from the data storage device. If the penalty for processing is greater than he penalty for retrieving the content from the data storage device and if erasure coding exists, then the edge network devices 408 can read the video data only to recover the remainder of the fragments made by erasure coding to reconstruct the information, and then send the content to the end points device 402. Otherwise, the edge network device 408 can read the entire content from the data storage device and send the packet to the end point device 402.

If the content is not stored locally on the edge network device 408 in the edge data center 410, the edge network device 408 requests the content from the data center 422. The data center 422 can send out the network coding packets to the edge network devices 408.

The edge network device can receive the contents from the data center 422 and check if the content is to be stored locally at the edge data center 410. If the data is to be stored locally, the edge network devices 408 can check if enough packets are received to build an erasure coding scheme within a predefined protection level and within a certain time window. Otherwise, the edge network device can send the packets to the user.

If enough packets were received by the edge network device 408, the edge network device 408 can code the data using erasure coding, store the coded data, and send the intended packets to the end point device 402. If the edge network device 408 did not receive enough packets, the edge network device 408 can check if enough packets are received to recover the original data within the time window. If enough packets are received, then the edge network device 408 can reconstruct the erasure coding scheme based on the recovered data, store the coded data, and send the content to the end point device 402. Otherwise, the edge network device 408 can request the data center 422 to resend the packets. Then the edge network device 408c can check if enough packets are received to build the erasure coding scheme again.

The edge network devices 408 can receive data from the data center 422. The integrated erasure coding scheme can be suitable for this type of infrastructure with inter-network edge devices 408 with both storage and computing functionalities. In some embodiments, the edge network devices 408 include microservers with storage and bandwidth resources that can download and/or store videos to respond to user requests for the videos.

In some embodiments, the infrastructure can be a part of video streaming service providers, internet service providers, and/or third parties such as nodes in large communities. In some embodiments, the edge network devices 408 can be used in an assisted Peer-to-peer structure and/or in an Openstack/Ceph structure with metadata services.

### Selection Between Data Transfer Policies

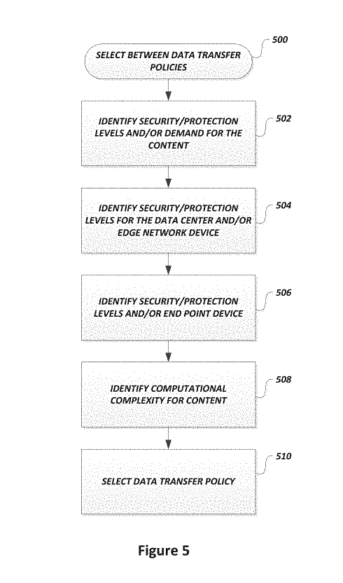

FIG. 5 is a flow diagram illustrating a selection between data transfer policies according to some embodiments of the present disclosure. The illustrated process can be executed by one or more elements of the network illustrated in FIG. 4, or elsewhere in the specification. In certain embodiments, the illustrated process can be at least partially implemented by an edge network device and/or an end point device. The process may also be performed by a processor that is separate from the edge network device and/or the end point device (such as, a data center, a software defined storage controller, a software defined network controller, and the like), by another device under directions from a separate processor, and the like.

The process starts at step 500. Next, in step 502, an edge network device can identify one or more security levels and/or protection levels for a content. The security and/or protection levels can include a certain amount of protection for a content, such as copyright. In some embodiments, the security and/or protection levels can include a threshold and/or a range that is indicative of a level or range of security/protection desired. In some embodiments, the security and/or protection levels can include adjustments for the security/protection. In some embodiments, the security and/or protection levels can be set by a publisher, a content owner, a user, and/or the like.

In some embodiments, the edge network device can identify the demand for a content. The demand can be indicative of an overall demand for content for a particular population and/or a subset of the population. For example, the demand can be high for a popular show. In some embodiments, the demand can be for an individual. In some embodiments, the demand can include a threshold and/or a range. The demand can be indicative of a likelihood of a demand for content.

Next in step 504, the edge network device can identify security/protection levels for the data center and/or the edge network device. The data center can include a database for storing the content. The data center can include a repository of one or more contents that the edge network device can request content from. The data center can include a security/protection level. For example, a higher security/protection level can be requested for a data center that stores a large volume of protected content. A higher security/protection level can be requested based on the available infrastructure of the data center, such as hardware or software with hacking prevention mechanisms.

In some embodiments, the edge network device can include a security/protection level. For example, if a particular edge network device is to connect to a large number of end points, is to encode and decode content at the edge network device to transmit to the end points, is to store the content locally, and/or the like, the edge network device can include a higher security/protection level.

Next in step 506, the edge network device can identify security/protection levels for the end point device. For example, a security/protection level for a mobile phone may be higher or lower than a personal computer laptop. The security/protection levels can depend on the available software and/or the platform that the content is to be sent to.

Next in step 508, the edge network device can identify a computational complexity for the content. For certain content, the edge network device can determine a higher computational complexity based on the number of base layers and/or enhancement layers. For example, the edge network device can determine a high computational complexity for high resolution video. In some embodiments, the edge network device can determine a computational complexity based on a security/protection level. For example, an edge network device may determine a larger number of parity blocks are required based on a higher security/protection level.

Next in step 510, the edge network device can select a data transfer policy to achieve desired level of protection. A data transfer policy can include data transfer with scalable video coding. A data transfer policy can include data transfer with scalable video coding and bit-level chunk coding. A data transfer policy can include data transfer with scalable video coding and erasure coding. A data transfer policy can include data transfer with scalable video coding with or without bit-level chunk coding and/or erasure coding. Bit-level chunk coding can include dividing data on bit level into n fragments such that any n−1 fragments are insufficient to recover the original data. For example, assuming 8-bit word size, each 8-bit word of data can be divided into 8 individual bits. The individual bits can be grouped for transmission, such as the first bits of each word can be grouped into a fragment.

In some embodiments, the below table illustrates data transfer policies arranged in the order of providing increased protection of data. For example, policy O0 can provide the lowest level of protection while policy O3 can provide the highest level of protection.

| Policy Code: | Policy: |
|---|---|
| O0 | Scalable Video Coding |
| O1 | Scalable Video Coding with Bit-Level Chunk Coding |
| O2 | Scalable Video Coding with Erasure Coding |
| O3 | Scalable Video Coding with Bit-Level Chunk and |
| | Erasure Coding |

In some embodiments, bit-level chunk coding can include dividing a file into a certain number of chunks. For example, an information block can include 8-bit words. Bit-level chunk coding can be used to divide the file into a certain number of chunks, such as eight chunks. In this example, each bit in the file can be indexed as B(i,j), where i=1, 2, . . . , N, and j=1, 2, . . . , 8. The eight chunks can include B(i,1), B(i, 2), . . . , B(i,8). Bit-level chunk coding may not require a parity bit.

In some embodiments, erasure coding with bit-level chunk coding can include the following. A file may be divided into pieces, such as by implementing bit-level chunk coding as described herein. If the number of the desired number of chunks is not a multiple of the total number of available chunks, the remaining portion can be assigned a certain value, such as a value of zero. Once the original file is divided into chunks, erasure coding can be used to divide the one or more chunks into one or more data chunks and one or more parity chunks.

### Selection Between Two Data Transfer Policies

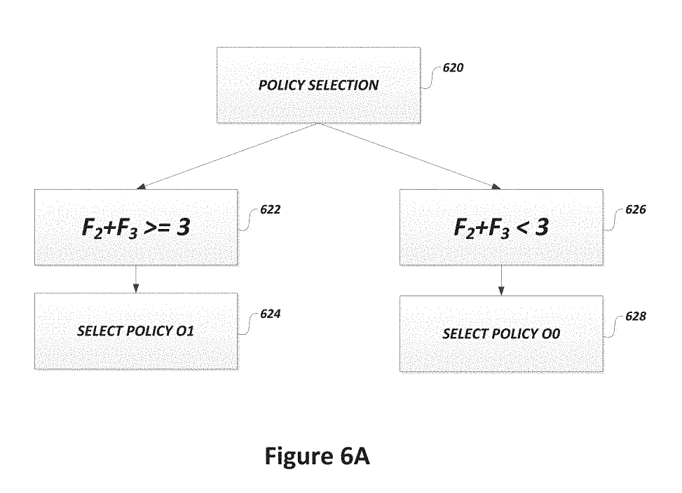

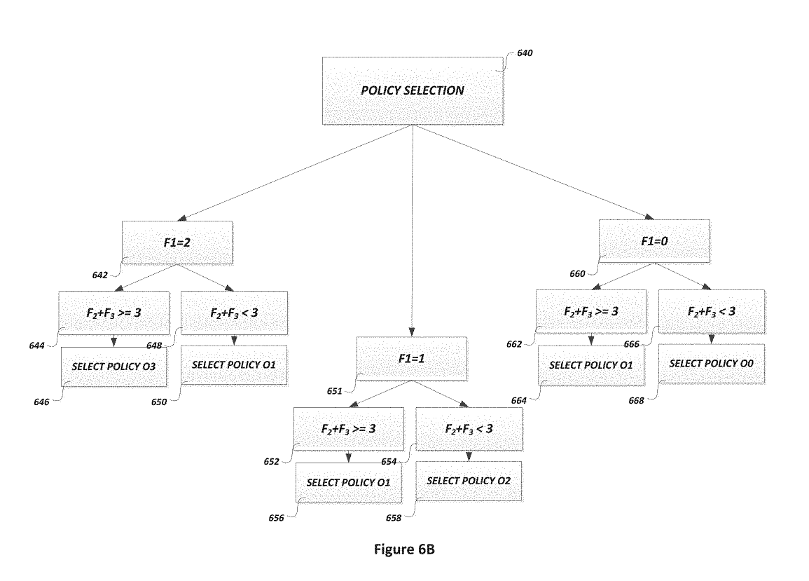

FIG. 6A is a decision tree diagram illustrating selection between two data transfer policies according to some embodiments of the present disclosure. The illustrated decision diagram can be executed by one or more elements of the network illustrated in FIG. 4, or elsewhere in the specification. In certain embodiments, the illustrated decision tree diagram can be at least partially implemented by an edge network device and/or an end point device. The process may also be performed by a processor that is separate from the edge network device and/or the end point device (such as, a data center, a software defined storage controller, a software defined network controller, and the like), by another device under directions from a separate processor, and the like.

The decision tree diagram begins in block 620. F₂ can include a security/protection level of the data center and/or the edge network device. F₃ can include a security/protection level of the end point device. In the example of FIG. 6A, if the combination of F₂ and F₃ is greater than or equal to a certain threshold level (such as, greater than or equal to a value of 3) at block 622, then the O1 policy can be implemented at block 624, which can correspond to data transfer using scalable video coding with bit-level chunk coding. However, if the combination of F₂ and F₃ is less than a certain threshold level (such as, less than a value of 3) at block 626, then the O0 policy can be implemented at block 628, which can correspond to data transfer using scalable video coding without bit-level chunk coding.

### Selection Between Data Transfer Policies

FIG. 6B is a decision tree diagram illustrating a selection between four data transfer policies according to some embodiments of the present disclosure. The illustrated decision diagram can be executed by one or more elements of the network illustrated in FIG. 4, or elsewhere in the specification. In certain embodiments, the illustrated decision tree diagram can be at least partially implemented by an edge network device and/or an end point device. The process may also be performed by a processor that is separate from the edge network device and/or the end point device (such as, a data center, a software defined storage controller, a software defined network controller, and the like), by another device under directions from a separate processor, and the like.

The decision tree diagram begins in block 640. F₁ can include an importance of the content itself, such as a security/protection level of the content. F₂ can include a security/protection level of the data center and/or the edge network device. F₃ can include a security/protection level of the end point device.

In the example of FIG. 6B, if F₁ is a certain value (such as, F₁ is 2) at block 624, then the edge network device selects between policies O3 and O1. If F₁ is of another value (such as, F₁ is 1) at block 651, then the edge network device selects between policies O1 and O2. If F₁ is a certain value (such as, F₁ is 0) at block 660, then the edge network device selects between policies O1 and O0. Advantageously, based on the importance of the content, the edge network device can select from an appropriate list of data transfer policies. For example, for high security/protection levels (such as, F₁ is 2), the edge network device can implement scaling video coding with bit-level chunk coding or scaling video coding with bit-level chunk coding and erasure coding.

In some embodiments, if the level of importance of the content is a certain value (such as, F₁ is 2) at block 624, the edge network device determines whether the combination of F₂ and F₃ is greater than or equal to a certain threshold level (such as, greater than or equal to a value of 3) at block 644 and 648. If the combination is greater than or equal to the threshold (such as, greater than or equal to a value of 3) at block 644, then policy O3 is selected at block 646, which corresponds to data transfer using scalable video coding with bit-level chunk coding and erasure coding. If the combination is less than the threshold (such as, less than a value of 3) at block 648, then policy O1 is selected at block 650, which corresponds to data transfer using scalable video coding with bit-level chunk coding but without erasure coding.

In some embodiments, if the level of importance of the content is lower (such as, F₁ is 1) at block 651, the edge network device determines whether the combination of F₂ and F₃ is greater than or equal to a certain threshold level (such as, greater than or equal to a value of 3) at block 652 and 654. If the combination is greater than or equal to the threshold (such as, greater than or equal to a value of 3) at block 652, then policy O1 is selected at block 656, which corresponds to data transfer using scalable video coding with bit-level chunk coding but without erasure coding. If the combination is less than the threshold (such as, less than a value of 3) at block 654, then policy O2 is selected at block 650, which corresponds to data transfer using scalable video coding with erasure coding but without bit-level chunk coding.

In some embodiments, if the level of importance of the content is the lowest available (such as, F₁ is 0) at block 660, the edge network device determines whether the combination of F₂ and F₃ is greater than or equal to a certain threshold level (such as, greater than or equal to a value of 3) at block 662 and 666. If the combination is greater than or equal to the threshold (such as, greater than or equal to a value of 3) at block 662, then policy O1 is selected at block 664, which corresponds to data transfer using scalable video coding with bit-level chunk coding but without erasure coding. If the combination is less than the threshold (such as, less than a value of 3) at block 668, then policy O0 is selected at block 668, which corresponds to data transfer using scalable video coding without erasure coding or bit-level chunk coding.

### Other Variations

Those skilled in the art will appreciate that in some embodiments additional system components can be utilized, and disclosed system components can be combined or omitted. Although some embodiments describe video data transmission, disclosed systems and methods can be used for transmission of any type of data. In addition, although some embodiments utilize erasure coding and/or scalable video coding, any suitable error correction schemes and/or data compressions schemes can be used. The actual steps taken in the disclosed processes, such as the processes illustrated in FIGS. 1B, 5, and 6A-6B may differ from those shown in the figures. Depending on the embodiment, certain of the steps described above may be removed, others may be added. Accordingly, the scope of the present disclosure is intended to be defined only by reference to the appended claims.

Any one or more embodiments described herein can be used in combination with any one or more embodiments described in a co-pending patent application titled “INTEGRATED ERASURE CODING FOR DATA STORAGE AND TRANSMISSION” (Atty. Docket No. WDA-3372-US-SILSP.341A), filed on the same day as the present application, the disclosure of which is hereby incorporated by reference in its entirety. While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. For example, the systems and methods disclosed herein can be applied to hard disk drives, hybrid hard drives, and the like. In addition, other forms of storage (such as, DRAM or SRAM, battery backed-up volatile DRAM or SRAM devices, EPROM, EEPROM memory, etc.) may additionally or alternatively be used. As another example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, references to “a method” or “an embodiment” throughout are not intended to mean the same method or same embodiment, unless the context clearly indicates otherwise.

The corresponding structures, materials, acts, and equivalents of all means or step plus function elements in the claims below are intended to include any structure, material, or act for performing the function in combination with other claimed elements as specifically claimed. The description of the various embodiments of the present disclosure has been presented for purposes of illustration and description, but is not intended to be exhaustive or limited to the embodiments disclosed. Many modifications and variations will be apparent to those of ordinary skill in the art without departing from the scope and spirit of this disclosure. The example embodiments were chosen and described in order to best explain the principles of this disclosure and the practical application, and to enable others of ordinary skill in the art to understand this disclosure for various embodiments with various modifications as are suited to the particular use contemplated.

Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A device comprising:
a memory; and
one or more processors configured to, in response to receiving a request to access video data from a user device, the video data encoded using erasure coding into a base layer of a scalable video coding scheme, the base layer comprising a plurality of base layer chunks and at least one parity layer chunk:
identify one or more base layer chunks of the plurality of base layer chunks not yet transmitted to the user device;
retrieve the one or more base layer chunks from the memory or request transmission of the one or more base layer chunks from a data center; and
transmit the one or more base layer chunks to the user device using network coding,
wherein each of the plurality of base layer chunks and the at least one parity layer chunk are required to be transmitted to the user device to enable playback of the video data by the user device.

2. The device of claim 1, wherein the one or more processors are further configured to:
determine that the at least one parity layer chunk has not yet been transmitted to the user device; and
in response to the determination, retrieve the at least one parity layer chunk from the memory or request transmission of the at least one parity layer chunk from the data center and transmit the at least one parity layer chunk to the user device.

3. The device of claim 1, the one or more processors are further configured to:
search for the one or more base layer chunks in the memory, wherein the memory is a local memory datastore;
in response to finding the one or more base layer chunks in the memory, retrieve the one or more base layer chunks from the memory; and
in response to not finding the one or more base layer chunks in the memory, request transmission of the one or more base layer chunks from the data center.

4. The device of claim 1, wherein at least one base layer chunk other than the one or more base layer chunks is stored by the user device.

5. The device of claim 1, wherein the video data is further encoded using erasure coding into at least one enhancement layer divided into a plurality of enhancement layer chunks each of which is required to playback enhanced video data by the user device, and wherein the one or more processors are further configured to:
identify one or more enhancement layer chunks of the plurality of enhancement layer chunks not yet transmitted to the user device;
retrieve the one or more enhancement layer chunks from the memory or request transmission of the one or more enhancement layer chunks from the data center; and
transmit the one or more enhancement layer chunks to the user device.

6. The device of claim 5, wherein at least one enhancement layer chunk other than the one or more enhancement layer chunks is stored by the user device.

7. The device of claim 5, wherein the video data is encoded into the base layer and the at least one enhancement layer using the scalable video coding scheme.

8. The device of claim 1, wherein the network coding comprises a butterfly network and a multicast session.

9. The device of claim 8, wherein the network coding comprises a modified butterfly network and two unicast sessions.

10. A system comprising the device of claim 1, wherein the device includes an edge network device.

11. A device comprising:
a memory; and
one or more processors configured to, in response to receiving a request to access data from a user device, the data comprising a base layer divided into plurality of base layer chunks each of which is required by the user device to access the data:
identify one or more base layer chunks of the plurality of base layer chunks not yet transmitted to the user device;
retrieve the one or more base layer chunks from the memory or request transmission of the one or more base layer chunks from a data center; and
transmit the one or more base layer chunks to the user device.

12. The device of claim 11, the one or more processors are further configured to:
search for the one or more base layer chunks in the memory, wherein the memory is a local memory datastore;
in response to finding the one or more base layer chunks in the memory, retrieve the one or more base layer chunks from the memory; and
in response to not finding the one or more base layer chunks in the memory, request transmission of the one or more base layer chunks from the data center.

13. The device of claim 11, wherein at least one base layer chunk other than the one or more base layer chunks is stored by the user device.

14. The device of claim 11, wherein the data further comprises at least one enhancement layer divided into a plurality of enhancement layer chunks each of which is required to access the data by the user device, and wherein the one or more processors are further configured to:
identify one or more enhancement layer chunks of the plurality of enhancement layer chunks not yet transmitted to the user device;
retrieve the one or more enhancement layer chunks from the memory or request transmission of the one or more enhancement layer chunks from the data center; and
transmit the one or more enhancement layer chunks to the user device.

15. The device of claim 14, wherein at least one enhancement layer chunk other than the one or more enhancement layer chunks is stored by the user device.

16. The device of claim 14, wherein the base layer is divided into the plurality of base layer chunks using erasure coding, and wherein the at least one enhancement layer is divided into the plurality of enhancement layer chunks using erasure coding.

17. The device of claim 11, wherein the one or more processors are further configured to transmit the one or more base layer chunks to the user device using network coding.

18. The device of claim 11, wherein the one or more processors are further configured to select a policy for transmitting the one or more base layer chunks to the user device, and wherein the policy is based on at least one of: a security level for the user device, a security level for the device, a demand for the data, or a computational complexity for the data.

19. A system comprising the device of claim 11, wherein the device includes an edge network device.

20. A method for transmitting data to a user device, the method comprising:
by a device, in response to receiving a request for content from a user device:
identifying one or more base layer chunks of a plurality of base layer chunks not yet received;
retrieving already received one or more base layer chunks of the plurality of base layer chunks from a memory of the device;
requesting the one or more base layer chunks not yet received from a data center;
receiving the one or more base layer chunks not yet received from a data center;
reconstructing the requested content based on the retrieved one or more base layer chunks and the received one or more base layer chunks, wherein each of the plurality of base layer chunks are required to reconstruct the requested content; and
transmitting the requested content to the user device.

21. The method of claim 20, further comprising selecting a policy for transmitting the one or more base layer chunks to the user device, wherein the policy comprises at least one of:
scalable video coding with bit-level chunk coding;
scalable video coding with erasure coding; or
scalable video coding with bit-level chunk and erasure coding.

22. The method of claim 21, wherein the policy is based on at least one of: a security level for the user device, a security level for an edge network device, a security level for a data center, a demand for the requested content, or a computational complexity for reconstructing the requested content.

23. A device comprising:
one or more processors configured to:
in response to receiving a request to access data from a user device, the data comprising a base layer divided into plurality of base layer chunks each of which is required by the user device to access the data:
identify one or more base layer chunks of the plurality of base layer chunks not yet transmitted to the user device;
retrieve the one or more base layer chunks from the memory or request transmission of the one or more base layer chunks from a data center; and
transmit the one or more base layer chunks to the user device.
